(19) United States
(12) Patent Application Publication
(10) Pub. No.: US 2022/0144707 A9
(43) Pub. Date: May 12, 2022

(54) SAGGER RECEIVING ELEMENT, IN PARTICULAR A SAGGER FOR BURNING POWDERY CATHODE MATERIAL FOR LITHIUM-ION ACCUMULATORS, AND MIXTURE THEREFOR

(71) Applicant: Saint-Gobain IndustrieKeramik Rödental GmbH, Rödental (DE)

(72) Inventor: Hans-Ulrich Dorst, Rödental (DE)

(21) Appl. No.: 17/256,454

(22) PCT Filed: Jun. 27, 2019
(86) PCT No.: PCT/EP2019/067254

§ 371 Date: Dec. 28, 2020

(30) Foreign Application Priority Data
Jun. 29, 2018 (DE) 10 2018 115 771.1

(51) Int. Cl. C04B 35/565

(52) U.S. Cl. CPC C04B 35/565; C04B 2235/3826; C04B 2235/349; C04B 2235/9669; C04B 2235/3201; C04B 2235/3272; C04B 2235/3463; C04B 2235/3418

(57) ABSTRACT

A sagger receiving element for burning powdery cathode materials for producing lithium ion accumulators including a rectangular shell comprising four side walls and a base, wherein the sagger receiving element is produced by a burning process from heat-resistant material which withstands temperatures of in particular more than 900° C., and wherein the material of the sagger receiving element is produced on the basis of oxide-bonded SiC, the material having the following chemical composition in percent by weight to a total of 100%: silicon carbide (SiC) content in a range of 40.0%-80.0%, Al₂O₃ content in a range of 10%-43%, total SiO₂ content in a range of 5%-30%, and alkali oxide and iron oxide content of less than 2%.

### BACKGROUND OF THE INVENTION

The invention relates to a sagger receiving element, and in particular, a sagger for burning a powdery cathode material for lithium-ion accumulators, and to a mixture for producing the receiving element.

Receiving elements or saggers of this type are used for burning powdery cathode materials which are used for producing lithium-ion accumulators. These saggers are formed from a shell-shaped housing, which is open upwards and is used in various sizes. These saggers generally have a substantially rectangular, usually square cross-section, for example of dimensions 330×330×100 mm and the like, and are formed by encircling side walls and a base. Saggers or containers of this type for burning cathode powder are generally also present in further sizes in the prior art, for example 250×250×100, 300×300×90, 300×300×100, 300×300×150, 330×330×100 or 330×330×150 (in mm in each case), the dimensions naturally also being variable between uses, and the specification given last in each case is representing the height of the side walls of the saggers.

For thermal preparation of the cathode material, the appropriate cathode powder is received in these saggers or containers and passed through burning chambers, the burning temperature generally being approximately 500° C. to 1000° C. It is clear that these saggers have to be formed from a material which readily withstands this temperature. These saggers are therefore produced from conventional materials suitable as burning aids, for example from mullite-cordierite, aluminium oxide-mullite-SiO₂, spinel, cordierite, and similar compositions, for example 50-70% Al₂O₃, 10-30% SiO₂ and 5-25% MgO.

These saggers or receiving elements formed from burning-resistant materials are, as stated above, used for burning powdery cathode material, there being a wide range of cathode materials, in particular for producing lithium-ion accumulators, which are pertinent and are known per se. Thus, a number of different cathode-active materials, which can vary in the compositions thereof, are used for producing lithium-ion accumulators on the market, in a manner specific to each manufacturer. Among other things, one problem with the saggers for burning these products is that they have to be appropriate for different cathode materials, and for saggers currently on the market for burning cathode materials of this type this sometimes has the result that they only have a limited service life, depending on the demands, and thus can only be used for a limited number of furnace cycles. In this context, it should be taken into account that the conventionally used cathode powders are extremely aggressive, and this can lead to considerable corrosion problems with the saggers. An increased Al₂O₃ content reduces the temperature change resistance, and an increasing cordierite content reduces the strength and fire-resistance, in particular after contamination with the cathode powder.

A major problem when cathode powders of this type are burned is also in particular that these different powders may have different constituents, in particular aggressive substances, such as Ni, Co, Li-hydroxide. This may result in flaking being able to occur after only a few furnace cycles, and this can result in highly undesirable contamination of the cathode powder. This would result in a corresponding loss of quality of the cathode powder, to the point of rejection. Further, aside from material flaking, cracks may also occur in the saggers and subsequently render them unusable. In this context too, it should be noted that, as a result of the aggressive cathode materials, considerable corrosion problems occur, whereby the saggers are exposed to high thermal cycling, and a nagger fracturing during the burning process would be highly disadvantageous.

As a result of rapidly increasing electric mobility, the need for suitable lithium-ion accumulators is increasing exponentially, as it were, in such a way that the production of accumulators of this type is dependent on problem-free burning of the aggressive cathode powder using suitable saggers, in such a way that the problem of corrosion due to the aggressive cathode powder and the risk of crack formations and deformations due to corrosion can be overcome. Thus, commercial acceptability of saggers is dependent on preventing flaking and impurities in the cathode powder from the nagger material during the burning process and ensuring long usage times, the prevention of crack formation and the like being of particular significance. Because the manufacturers of accumulators use completely different cathode powder compositions, commercial acceptability of the saggers is in particular dependent on a wide range of cathode powder types being able to be used therewith, in other words to be burned without any problems.

At present, it stands out that in future a high need, which will increase considerably in the coming years, for burning saggers of this type and cathode-active powder materials required therefor will be used on the basis of NMC materials (such as Li(Ni⅓Mn⅓Co⅓)O2) and LCO materials (such as LiCoO2). Further materials are so called NCA (such as Li(Ni80Co0.15Al0.05)O2), LFP (such as LiFePO4), LMO (such as LiMn2O4′) and the like. In view of the high need for lithium-ion accumulators, it is clear that saggers suitable for corresponding commercial acceptability need to be provided.

### SUMMARY OF THE INVENTION

The inventor has taken on the aim of making the saggers for burning cathode powders of this type more functional, in particular creating saggers or receiving elements with a higher life expectancy, with a reduction in the risk of cracks occurring and in the risk of flaking. In addition, the saggers should make good results possible even for highly aggressive cathode powders, this having to do in particular with service life, corrosion resistance and temperature change resistance.

This is also the object of the patent, namely to overcome the drawbacks of the saggers used thus far for burning cathode powders for producing in particular lithium-ion accumulators and to provide saggers which are distinguished by an improved life expectancy, corrosion resistance and temperature resistance as well as improved functionality. Another major aim is to prevent or reduce contamination or impurity of the cathode powder from the sagger material itself. The aim is to form a firmly adhering corrosion layer of a low thickness, as tightly as possible and without flaking components. The protective layer of the desired density should be appropriate for aggressive constituents of the cathode powder and in particular reduce or prevent the formation of Li-silicate. A further aspect relates to a suitable mixture for producing saggers of this type.

### DETAILED DESCRIPTION OF THE PREFERRED EMBODIMENTS

According to the invention, this object is achieved for saggers of this type by way of a material selection, which is based on the saggers being produced on the basis of oxide-bonded silicon carbide SiC-material, the material of the sagger having the following chemical composition in percent by weight to a total of 100%:

silicon carbide (SiC) content in a range of 40.0-80.0%,

Al₂O₃ content in a range of 10-43%,

total SiO₂ content (including silica phase) in a range of 5.0-30%,

alkali metal oxide and iron oxide content of less than 2%.

The total SiO₂ content or silicon dioxide content is not only SiO₂ from the silica phase, but also additional SiO₂, for example from mullite.

Other constituents may be oxides such as MgO, magnesium silicate, spinel (MgAl₂O₄) and the like, preferably in a range of 1% to 5%.

The SiC content may for example be measured using a Horiba apparatus, for example a Horiba EMIA-820, in accordance with the standard ANSI B74.15-1992-(R2007).

The other elements or oxides, such as the total SiO₂, with the exception of SiC, may be measured by X-ray fluorescence analysis methods.

The silica phase content can be measured by chemical methods.

The silica phase means a phase where silicon dioxide (SiO₂) is not combined with aluminium oxide (Al₂O₃). This may in particular be a pure SiO₂ phase, such as quartz, cristobalite; and/or an SiO₂ glass phase; an SiO₂ phase for example comprising sodium oxide and/or also a crystalline phase such as sodium silicates, but in particular without aluminium oxide and in any case with the exception of mullite.

It is possible to measure the silica phase content as follows. The sample is milled to a fineness smaller than approximately 100 μm. After an attack by hydrofluoric acid (40% by weight) at a temperature of −16° C., filtration, and measurement of the residue by gravimetry, this silica phase is determined.

The content of phases such as mullite and corundum can be measured by diffraction analysis using X-rays and the Rietveld method.

Tests have shown that, by way of this material selection according to the invention, optimum thermal conductivity is achieved by comparison with conventional nagger materials, the expectation being that this is due to the appropriate SiC content.

At the same time, the defined porosity achieves firm adhesion of the corrosion layer. A further advantage is that process-related evaporations of the impurities and the like mentioned at the outset which are contained in the cathode material can be received by way of the naggers.

Further, particularly advantageously, an improved temperature change resistance occurs when saggers or receiving elements of this type are used, this being predominantly due to the high content of SiC constituents. The term “saggers” used herein is already understood within the context of the invention. This includes containers, transport boxes and the like.

By comparison with materials used to date, which in particular have high mullite levels and contain cordierite, there is further the advantage of higher cold-bending and hot-bending resistance and improved reaction properties, in particular high corrosion resistance and an improvement in the plastically producible material, so as to obtain a uniform spatial weight distribution, this in turn being favourable for the temperature change resistance. Further, by way of these materials, improved and long-lasting fire resistance is achieved, in such a way that, as has been shown in practice, the occurrence of cracks is reduced, even after a plurality of furnace cycles and contamination.

Expediently, the silicon carbide is used in a range of 52.0-72.0% by weight, a more limited range of particular 60.0-71.0% being preferred in particular for optimisation as regards susceptibility to cracks even after many furnace cycles, in particular a content of 65.0 to 68.0% by weight.

Further, a limited range of an Al₂O₃ content of 19.0-35.0% for the Al₂O₃ content, in particular 19.5-26.0% by weight, is expedient, likewise with a view to optimisation as regards susceptibility to cracks, as well as a corundum admixture, so as to set the Al₂O₃ content of the nagger material to an Al₂O₃ content of expediently 19.0% to 43.0%.

Ranges of this type, in particular materials of this type, also lead to optimum cold-bending strength of saggers of this type and an increased oxidation resistance, this being of importance in cathode powder production since with operating temperatures of 900° C. and above there is also concern as regards low-temperature oxidation. Thus, by way of these materials, increased strength, increased oxidation resistance and also reduction in the risk of crack formation are achieved, it also being possible to prevent flaking of sagger material into the cathode powder, which would otherwise detract from the use of the cathode powder thus burned or render it unusable.

The tests have shown that this material selection, in particular a limited range of a silica phase, leads to optimisation between bonding, thermal conductivity and corrosion resistance.

In other words, an excessively high silica phase leads to a low thermal conductivity, whilst a low silica content leads to a low cold-bending strength, whilst a high free silicon dioxide content can reduce the corrosion resistance. Expediently, the silicon carbide for a single sagger material is used in a mixture of at least three different particle sizes. In this context, silicon carbide having a particle size of 80/220 (mesh) at a content of 3.0-27.0% by weight, silicon carbide having a particle size of 30/70 (mesh) at a content of 23.0-54.0% by weight, silicon carbide having a particle size of 16/24 (mesh) at a content of 7.0-25.0% by weight are advantageously present, preferably to a maximum of 82% by weight SiC. However, other particle sizes would also be appropriate. Specifications are given in mesh herein.

Preferably, the Al₂O₃ component is added by way of a clay and/or corundum content, and SiO₂ is added by way of an SiO₂ carrier.

Preferably, the SiO₂ carrier is formed on the basis of 90% SiO₂.

The latter is preferably added in a very fine particle size as powder, in other words at a particle size of preferably 100 μm, in particular 50 μm, expediently <45 μm.

Remainders of the carrier component based on SiO₂ are highly desirable, as well as normal impurities such as oxides of alkali and the like.

According to the invention, material in which the silicon carbide (SiC) content is in a range of 40.0-82.0% by weight and the range of the Al₂O₃ content is in the range of 10.0-43.0% by weight, preferably in particular 15%-43% or in particular 19%-43% is advantageously used for these saggers. Expediently, a content of the SiO₂ carrier varies in a range of 5.0-15.0%, in particular 7.0% by weight.

Further, high-grade corundum may also be added for the Al₂O₃ content, specifically at a particle size of 0-0.15 mm, specifically at a content of at least 12.0% by weight, preferably 15% by weight.

A cellulose content in the mixture of 0.3-0.7% is expedient so as also to optimise the material formation in terms of plastic deformability of the material.

It should be noted that according to the invention saggers are produced from heat-resistant materials in a burning process, in such a way that they can withstand temperatures of more than 900° C. during burning of powdery cathode materials or alkali-rich, powdery bulk materials, which are likewise subjected to a burning process. Preferably, a mixture of powdery materials, which is formed from an oxide-bonded silicon carbide mixture and an Al₂O₃ content in the form of clay and optionally also an admixture of corundum and a powdery SiO₂ carrier or on the basis of at least 90% SiO₂, preferably more than 95% SiO₂ having an average particle size preferably in a range of 40-150 μm, in particular 40-100 μm, is used as the starting material for producing these saggers. The remaining content of the SiO₂ carrier is formed from normal impurities, such as Fe₂O₃, Al₂O₃ and/or alkali oxides and/or alkaline earth oxides and the like. The content of SiO₂ carrier is preferably 5.0 to 15.0% by weight, preferably approximately 5.0 to 7.0% by weight. The percentage specifications given herein refer to % by weight in each case unless stated otherwise.

This material is preferably subjected to a mixing process to produce the naggers, the mixing time expediently being in a range of 3-8 minutes, although this is not intended to be in any way limiting.

With an appropriate admixture of water, the material is kneaded in such a way that a plastically deformable mass forms, which is shaped into the nagger and subsequently burned. In this context, the water content is suitably set, preferably to a range of 3.5%-6.5%, in such a way that the appropriate plastic deformability of the material comes about.

In this context, it is expedient to add conventional plasticisers, specifically at a content of up to 10.0%, in particular to a maximum of 8.0%. In this context, conventional commercial plasticisers known per se to a person skilled in the art may be used, such as 50% micro-milled clay, for example having a particle size of <63 μm, as well as cellulose and similar pasting materials. The processing humidity in this context is suitably set.

With a view to improved plasticisation of the material, due to a higher fine content and a higher content of free carbon so as to achieve a higher density for the same pressing force and thus also to improve the technical properties such as flexural strength, in the context of the invention it is particularly expedient to add a content of 1.5-2.5% silicon carbide in which the impurity level is comparatively high. In this context, it is expedient for this constituent to comprise pure silicon carbide at approximately 90.0-92.5%, the remainder being formed by impurities, this being expedient for the invention in this case. The addition of this as it were impurified silicon carbide portion is expedient in the context of the invention, specifically with a view to an increase in strength and to preventing crack formation or reducing fracture susceptibility

In the context of the invention, it is expedient to form the aluminium oxide content from clay or a mixture of corundum and clay, specifically expediently at a content of at most 12.0% corundum and a content of 25.0-30.0% clay.

Corundum, clay and aluminium hydroxide are readily commercially available, and the conventional commercially available products are well-suited to this use. The advantage of clay or aluminium hydroxide is predominantly that the content thereof is cleaner in terms of alkalis, and has a finer particle structure and higher reactivity.

After the burning process, the burned sagger, in other words the product ready for use for burning cathode powder, preferably has as a main constituent a particularly preferred content of 52.0-70.0% by weight SiC C, a content of SiO₂ of 5.0-15.0%, and an Al₂O₃ content of 19.0-30%. Remainders would be impurities to a maximum of 1%, preferably 0.7%, specifically in particular of the usual impurities, such as iron oxide, alkali and oxides, etc.

Increased porosity of the naggers after the burning process is advantageous, the open porosity being in a range of 15-22%, preferably in a range of 18-21%, meaning that an increased content of contaminations can be received during the burning process. As a result, flaking and the like can be prevented effectively.

For the strength, it is preferred to set the bulk density of the sagger to 2.50-2.60 g/cm³.

In addition, it should be noted that the above-mentioned percentage specifications are to be understood in percent by weight, with the exception of the porosity in percent by volume.

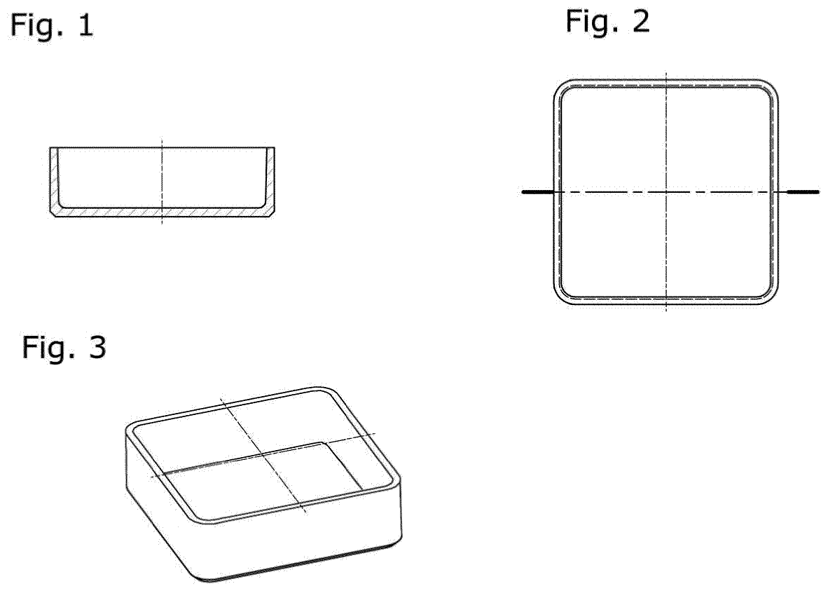

The accompanying FIGS. 1 to 3 show a sagger such as is conventionally used for burning cathode materials for lithium-ion accumulators. It can be seen that this is a shell comprising four peripherally arranged side walls and a base.

FIG. 1 is a sectional view,

FIG. 2 is a plan view, and

FIG. 3 is a perspective view.

If required, and while remaining within the scope of the invention, conventional burning aids in a shell-shaped structure may be provided with a coating of the above-mentioned materials, whereby the burning of cathode material can also, highly advantageously, be suitably implemented.

Hereinafter, purely by way of example, suitable material mixtures according to the invention from which the nagger is produced are set out in brief.

Example 1 (No. 1)

| | |
|---|---|
| SiC | 67.0% |
| Clay (Al₂O₃) | 25.5% |
| SiO₂ carrier | 6.5% |
| Remainder impurities | |

The silicon carbide is present in powder form as an oxide-bonded SiC mixture, expediently at a particle size of SiC mesh 80/220 in a range of 4-8%, SiC mesh 30/70 in a range of 43-47%, and SiC mesh 16/24 in a range of 11-16%, extremely fine powder having a size of <100 μm also being present at up to 0.1%, in particular in the form of Totanin powder.

Clay is present in powder form, expediently at a particle size of 0-0.08 mm, various types of clay being suitable, in particular clay of an average particle size of 3 μm to 5 μm being available.

Example 2 (No. 2)

| | |
|---|---|
| SiC | 74.0% |
| Clay (Al₂O₃) | 19.5% |
| SiO₂ carrier | 5.0% |
| Remainder impurities | |

The silicon carbide is expediently present as an oxide-bonded SiC mixture having a particle size expediently in the following contents: SiC mesh 80/200 in a range of 5-9%, SiC mesh 30/70 in a range of 47-54%, SiC mesh 16/24 in a range of 13-19%, it being possible in this case too for extremely fine particles having a size of <100 μm to be added within a range of up to 2%.

In particular powdery, highly reactive clay is suitable as the clay.

Example 3

| | |
|---|---|
| SiC | 54.0% |
| Clay (Al₂O₃) | 34.0% |
| SiO₂ carrier | 10.0% |
| Remainder impurities | |

In this case too, the oxide-bonded SiC is in the form of a powdery SiC mixture, specifically preferably having a particle size content of SiC mesh 80/220 in a range of 3-7%, SiC mesh 30/70 in a range of 33-39%, and SiC mesh 16/24 in a range of 9-13%, it also expediently being possible for the clay to be added in extremely fine particles <100 μm at 0.5-2%.

As in the above examples, various types of clay are suitable for the Al₂O₃ content of this composition, specifically including those having the trade names set out in the other examples.

Example 4

| | |
|---|---|
| SiC | 41.0% |
| Clay (Al₂O₃) | 42.5% |
| SiO₂ carrier | 14.5% |
| Remainder impurities | |

The silicon carbide is preferably present in an oxide-bonded SiC mixture, the following ranges being expedient: SiC mesh 80/220 in a range of 3-6%, SiC mesh 30/70 in a range of 23-29%, and SiC mesh 16/24 in a range of 7-11%, as well as extremely fine particles of SiC <100 μm at 0.5-2%, the percentage specifications being given in percent by weight.

Accordingly, powdery clay is suitable as the clay, expediently having a particle size of 0-0.08 mm, in particular corundum, as well as clay having an average particle size of 5 μm and having an Al₂O₃ content higher than 99.5% by weight, but also other clays, being suitable as the clay. The corresponding selection can readily be made by a person skilled in the art. A plurality of suitable clays are available for this purpose.

The following table gives a chemical analysis of the material components of the produced naggers for the two mixtures of Examples 1 and 2, including the methods and devices used for the analysis.

| Examples in the | | No. 1 | No. 2 |
|---|---|---|---|
| description | | Example 1 | Example 2 |
| Mixture | Material composition | wt. % | wt. % |
| SiC | | 67 | 74 |
| Clay (Al₂O₃) | | 25.5 | 19.5 |
| SiO₂ carrier | | 6.5 | 5.0 |
| Remainder impurities | | | |
| Chemical analysis | Method/Standard | wt. % | wt. % |
| SiC | ANSI B74.15-1992-(R2007) | 65.5% | 72% |
| | After calcination at 750° C. | | |
| | without weight recovery | | |
| Al₂O₃ | X-ray fluorescence analysis | 24.5% | 19.0% |
| Total SiO₂ content | X-ray fluorescence analysis | 8.9% | 8.0% |
| Na₂O + K₂O + Fe₂O₃ + TiO₂ | X-ray fluorescence analysis | <1% | <1% |
| CaO + MgO | X-ray fluorescence analysis | <1% | <1% |
| Other oxides | X-ray fluorescence analysis | <0.5% | <0.5% |
| Total | | 100% | 100% |
| Silicate phase | Chemical analysis | 6 wt. % | 5 wt. % |
| | Milling of sample to 100 | | |
| | μm | | |
| | 1 g powder attacked with | | |
| | hydrofluoric acid (40%) at | | |
| | temperature of −16° C. | | |
| | Filtration and | | |
| | determination of residue | | |
| | by gravimetry | | |
| Phases measured by | D8 Endeavor de BRUKER | | |
| diffraction analysis | HighScoresoftware | | |
| using X-rays | Rietveld refining | wt. % | wt. % |
| SiC | | 65 | 71 |
| Mullite | | 17 | 15 |
| Corundum | | 15 | 10 |
| Cristobalite | | 3 | 4 |
| | Method/Standard/Unit of | | |
| Physical analysis | measure | | |
| Bulk density | kg/dm³ (ISO5017) | 2.55 | 2.58 |
| Open porosity | vol. % | 21.0 | 20.5 |
| | Standard ISO 5017 | | |

The SiC content was measured using a Horiba EMIA-820, in accordance with Standard ANSI B74.15-1992-(R2007).

The other elements or oxides, such as the total SiO₂, with the exception of SiC, were measured by X-ray fluorescence analysis.

The silica phase content was measured by chemical methods. In this context, silica phase means a phase in which silicon dioxide (SiO₂) is not combined with aluminium oxide (Al₂O₃). This may in particular be a pure SiO₂ phase, such as quartz, cristobalite; and/or an SiO₂ glass phase; an SiO₂ phase for example comprising sodium oxide and/or a crystalline phase such as sodium silicates, but in particular without aluminium oxide and in any case with the exception of mullite.

The sample was milled to a fineness smaller than approximately 100 μm. After an attack by hydrofluoric acid (40% by weight) at a temperature of −16° C., filtration, and measurement of the residue by gravimetry, this silica phase is determined.

The content of phases such as mullite and corundum was measured by diffraction analysis using X-rays and the Rietveld method.

In particular the materials available under the trade name Microsilica, in a suitable powdery form, are suitable as an SiO₂ carrier.

In all the above examples, the SiO₂ carrier is preferably added at an extremely small particle size, in other words at a particle size preferably <100 μm, in particular <50 μm, expediently <45 μm. The SiO₂ carrier is preferably based on 90% SiO₂; remainders of the carrier component are highly desirable as well as normal impurities such as oxides of iron, alkali and alkaline earths and the like.

In these examples, it has been found that a breaking strength of at least 15 MPa when cold, of approximately 25 MPa at a temperature of 1000° C. and of approximately 15 MPa at a temperature of 1400° C. occurs, this being an indicator of the excellent breaking strength of the saggers produced from the above-mentioned materials. This means that flaking is still prevented when a wide range of cathode material is used and the fracture susceptibility is also greatly reduced, in such a way that the saggers endure much longer operating times.

Overall, the nagger material or fitting material according to the invention overcomes the drawbacks of the prior art in that much greater strength is achieved and the temperature change resistance is also increased and the risk of fracture susceptibility is reduced. To date, the problem of conventional saggers is that they have to be replaced with new saggers frequently as a result of contamination during the burning process of the cathode material, and this causes a large amount of special waste which can be disposed of by way of expensive recycling processes.

1.-15. (canceled)

16. A sagger receiving element for burning powdery cathode materials for producing lithium ion accumulators, comprising:
a rectangular shell comprising four side walls and a base;
wherein the sagger receiving element is produced by a burning process from heat-resistant material which withstands temperatures of in particular more than 900° C.; and
wherein the material of the sagger receiving element is produced on the basis of oxide-bonded SiC, the material having the following chemical composition in percent by weight to a total of 100%:
silicon carbide (SiC) content in a range of 40.0%-80.0%;
Al₂O₃ content in a range of 10%-43%;
total SiO₂ content in a range of 5%-30%; and
alkali oxide and iron oxide content of less than 2%.

17. The sagger receiving element according to claim 16, wherein the SiC content is in the range of 50.0%-70.0%.

18. The sagger receiving element according to claim 16, wherein the Al₂O₃ content is in the range of 15%-35%.

19. The sagger receiving element according to claim 18, wherein the Al₂O₃ content is in the range of 20%-30%.

20. The sagger receiving element according to claim 16, wherein the SiO₂ content is in the range of 7%-20%.

21. The sagger receiving element according to claim 20, wherein the SiO₂ content is in the range of 8%-15%.

22. The sagger receiving element according to claim 16, wherein the material of the sagger receiving element has the following chemical composition in percent by weight to the total of 100%:
Al₂O₃ content as corundum and mullite in a range of 10.0%-40.0%;
mullite (Al₆Si₂O₁₃); and
silica phase of less than 10%.

23. The sagger receiving element according to claim 22, wherein the Al₂O₃ content is in the range of 13.0%-30.0%.

24. The sagger receiving element according to claim 22, wherein the silica phase is less than 8%.

25. The sagger receiving element according to claim 16, wherein the mullite (Al₆Si₂O₁₃) is provided at a content of less than 25%.

26. The sagger receiving element of claim 25, wherein the mullite (Al₆Si₂O₁₃) content is less than 20%.

27. The sagger receiving element according to claim 16, wherein the material has the following composition in percent by weight:
silicon carbide (SiC) content in a range of 50.0%-70.0%;
Al₂O₃ content as corundum in a range of 13.0%-30%;
mullite (Al₆Si₂O₁₃) content of less than 20%;
silica phase of less than 7%; and
alkali oxide and iron oxide content of less than 1%.

28. The sagger receiving element according to claim 16, wherein an average particle size of an SiC particle size is less than 500 μm.

29. The sagger receiving element according to claim 16, wherein a bulk density of the sagger receiving element is in a range of 2.50 g/cm³-2.60 g/cm³.

30. The sagger receiving element according to claim 16, wherein the sagger receiving element has an open porosity in a range of 15%-22%.

31. The sagger receiving element of claim 30, wherein the open porosity range is 18%-21%.

32. A mixture for producing the sagger receiving element according to claim 16, the silicon carbide content in a range of 40.0%-82.0% by weight and an average particle size of <500 μm, the aluminium oxide having a powdery Al₂O₃ content in the range of 10.0%-43.0% by weight, and the silica dioxide having a powdery SiO₂ carrier based on at least 90% SiO₂ and a particle size of <100 μm, is used for a single sagger material in a powder mixture, the remainder being impurities.

33. The mixture of claim 32, wherein the Al₂O₃ content is in the range of 15.0%-35.0%.

34. The mixture of claim 33, wherein the Al₂O₃ content is in the range of 19.5%-26.0%.

35. The mixture of claim 32, wherein the powdery SiO₂ carrier is based on at least 95% SiO₂ by weight.

36. The mixture of claim 32, wherein the powdery SiO₂ carrier particle size is less than 50 μm.

37. The mixture of claim 36, wherein the powdery SiO₂ carrier particle size is less than 45 μm.

38. The mixture according to claim 32, wherein the SiO₂ carrier is present at a content of 5% to 15% by weight.

39. The mixture according to claim 38, wherein the SiO₂ carrier is present at a content of 5%-7% by weight.

40. The mixture according to claim 32, wherein the material is mixed and kneaded with an admixture of water, and, from the plastically deformable material produced therefrom, the nagger receiving element is shaped and burned.

41. The mixture according to claim 32, wherein the SiC content is formed from the mixture having a varied particle size of 3%-9% (% by weight) SiC mesh 80/220 having an average particle size in millimetres of 0.1 mm-0.35 mm, a content of 23%-54% (% by weight) of SiC mesh 30/70 having an average particle size in millimetres in a range of 0.35 mm-0.85 mm, a content of SiC mesh 16/24 of 7%-19% (% by weight) having an average particle size in a range of 0.85 mm-1.5 mm, and an SiC content of 0.5%-1% (% by weight) at an average particle size ≤ 100 μm, the maximum content of SiC being 82% by weight.

42. The mixture of claim 41, wherein the SiC mesh 80/220 has an average particle size of less than 0.25 mm.

43. The mixture of claim 41, wherein the SiC mesh 30/70 has an average particle size of 0.25 mm-0.71 mm.

44. The mixture of claim 41, wherein the SiC mesh 16/24 of has an average particle size of less than 1.0 mm.

45. The mixture of claim 41, wherein the SiC content has an average particle size of greater than or equal to 20 μm.

46. The mixture of claim 45, wherein the SiC content has an average particle size of 20 μm-45 μm.

47. The mixture of claim 46, wherein the SiC content has an average particle size of 30 μm-37 μm.

48. The mixture according to claim 41, wherein the SiC mixture is formed from 4%-8% by weight SiC mesh 80/220, 43%-54% by weight SiC mesh 30/70, 11%-16% by weight SiC mesh 16/24, and SiC extremely fine particulate having a particle size ≤ 100 μm at up to 1% by weight.

49. The mixture according to claim 32, wherein the Al₂O₃ content is formed from corundum and/or clay, comprising 19%-35% by weight clay, at least 12% by weight corundum.

50. The mixture according to claim 49, wherein the clay is 19%-26% by weight.

51. The mixture according to claim 49, wherein the corundum is at least 15% by weight.

52. The mixture according to claim 32, wherein after the burning process, the sagger receiving element comprises silicon carbide at a content of 40%-75% by weight, an SiO₂ content of 5.0%-15.0% by weight, an Al₂O₃ content of 19.0%-26.0% by weight, remainder clay and impurities at at most 1.0% of iron oxide, alkali.

53. The mixture according to claim 52, wherein the content of silica carbide after the burning process is 52.0%-70.0% by weight.

54. The mixture according to claim 52, wherein the SiO₂ content after the burning process is 5.0%-7.0% by weight.

55. The mixture according to claim 52, wherein the Al₂O₃ content after the burning process is 23.0%-26.0% by weight.

56. The mixture according to claim 52, wherein the remainder clay and impurities is less than 0.7% by weight.
